(19) United States
(12) Patent Application Publication
(10) Pub. No.: US 2013/0229672 A1
(43) Pub. Date: Sep. 5, 2013

(54) APPARATUS AND METHOD OF CONTROLLING APPARATUS

(71) Applicant: CANON KABUSHIKI KAISHA, Tokyo (JP)

(72) Inventor: Taketomo Naruse, Yokohama-shi (JP)

(73) Assignee: CANON KABUSHIKI KAISHA, Tokyo (JP)

(21) Appl. No.: 13/768,898

(22) Filed: Feb. 15, 2013

(30) Foreign Application Priority Data
Mar. 5, 2012 (JP) 2012-048619

(51) Int. Cl. H04N 1/00

(52) U.S. Cl. CPC H04N 1/00896
USPC 358/1.13

(57) ABSTRACT

An apparatus including a communication unit configured to be able to perform wireless communication with a communication device in a sleep state or a soft-off state stores device information representing the device status of the apparatus in a memory accessible when the communication unit performs the wireless communication. The apparatus determines, based on the device information stored in the memory, whether to execute predetermined processing in the sleep state or the soft-off state. When it is determined to execute the predetermined processing, the apparatus shifts from the sleep state or the soft-off state to an activation state and executes the predetermined processing. When it is determined not to execute the predetermined processing, the apparatus keeps the sleep state or the soft-off state.

### BACKGROUND OF THE INVENTION

1. Field of the Invention

The present invention relates to an apparatus and a method of controlling apparatus.

2. Description of the Related Art

Among information processing apparatuses, there are apparatuses which change the power supply state to a hard-off state in which no power is supplied, a soft-off state in which the main program is not activated though power is supplied, a sleep state in which it is controlled to minimize power consumption through the main program is activated, and a normal activation state in which a program runs normally. An information processing apparatus is known which is automatically activated when a job is input from an external terminal to the apparatus in the sleep state. There is also an apparatus which activates a program triggered by some signal even in the soft-off state and processes a job. For example, Japanese Patent Laid-Open No. 2007-004540 discloses an invention in which a power supply state is read using vicinity communication to control the power supply of an apparatus.

The above-described information processing apparatuses have the following problems. Since the state of the information processing apparatus is not known in the soft-off state and sleep state, the user of an external terminal may be uncertain whether he can normally process a job. Since time is taken until the device starts up to the normal activation state after a job is input, the user has to wait in front of the information processing apparatus until the device is activated to the normal activation state. If an error occurs upon the activation, the user wastes the work and time so far.

An MFP (Multi Function Printer) will be taken as an example. The MFP has the print function, scan function, FAX function, and the like, and further has a function of changing the settings of them. Assume that the user of an external terminal wants to process a print job by the MFP. When the MFP is in the soft-off state, whether its print function normally operates is not unclear until the MFP starts up to the normal activation state. If an error is displayed after the start-up of the MFP, the time of wait for the start-up of the MFP is wasted. Further, when the MFP is an inkjet printer, some recovery operation may be performed to wastefully consume consumables such as ink.

### SUMMARY OF THE INVENTION

According to one embodiment of the present invention provides an information processing apparatus and system which avoid the above-mentioned wastes by controlling activation or return of the information processing apparatus when a job is input to the information processing apparatus and the information processing apparatus is in a state such as an error or warning state in which it cannot perform a normal operation.

According to one aspect of the present invention, there is provided an apparatus comprising: a communication unit configured to be able to perform wireless communication with a communication device in a sleep state or a soft-off state; a storage unit configured to store device information representing a device status of the apparatus in a memory accessible when the communication unit performs the wireless communication; a determining unit configured to determine, based on the device information stored in the memory, whether to execute predetermined processing in the sleep state or the soft-off state; and a control unit configured to, when the determining unit determines to execute the predetermined processing, shift the apparatus from the sleep state or the soft-off state to an activation state and execute the predetermined processing, and when the determining unit determines not to execute the predetermined processing, keep the sleep state or the soft-off state.

According to another aspect of the present invention, there is provided a method of controlling an apparatus including a communication unit configured to be able to perform wireless communication with a communication device in a sleep state or a soft-off state, comprising: a storage step of storing device information representing a device status of the apparatus in a memory accessible when the communication unit performs the wireless communication; a determining step of determining, based on the device information stored in the memory, whether to execute predetermined processing in the sleep state or the soft-off state; and a control step of, when the predetermined processing is determined in the determining step to be executed, shifting the apparatus from the sleep state or the soft-off state to an activation state and executing the predetermined processing, and when the predetermined processing is determined in the determining step not to be executed, keeping the sleep state or the soft-off state.

Further features of the present invention will become apparent from the following description of exemplary embodiments with reference to the attached drawings.

### BRIEF DESCRIPTION OF THE DRAWINGS

FIG. 1 is a view exemplifying the arrangement of a wireless communication system according to an embodiment;

FIG. 2 is a view showing the outer appearance of a portable communication terminal according to the embodiment;

FIGS. 3A and 3B are views showing the outer appearance of an MFP according to the embodiment;

FIGS. 4A and 4B are conceptual views of a passive mode in NFC communication;

FIGS. 5A and 5B are conceptual views of an active mode in NFC communication;

FIG. 6 is a block diagram exemplifying the schematic arrangement of the portable communication terminal;

FIG. 7 is a block diagram exemplifying the schematic arrangement of the MFP;

FIG. 8 is a block diagram for explaining details of an NFC unit;

FIG. 9 is a block diagram exemplifying the data structure of the RAM of the MFP;

FIG. 10 is a block diagram exemplifying the data structure of the NFC memory of the MFP;

FIG. 11 is a flowchart showing processing when the NFC unit operates as an initiator;

FIG. 12 is a chart showing a sequence to exchange data in the passive mode;

FIG. 13 is a chart showing a sequence to exchange data in the active mode;

FIG. 14 is a flowchart showing switching of processing in accordance with the power supply state upon inputting a job;

FIG. 15 is a flowchart showing processing by the MFP when the MFP is in the normal activation state upon inputting a job;

FIG. 16 is a flowchart showing processing by the MFP when the MFP is soft-off or in the sleep state upon inputting a job;

FIG. 17 is a flowchart showing processing by the portable communication terminal when the MFP is in the hard-off state upon inputting a job;

FIG. 18 is a table for explaining the relationship between the device status of the MFP and whether a job can or cannot be executed; and

FIG. 19 is a flowchart showing processing of writing the device status of the MFP in the NFC memory of the MFP.

### DESCRIPTION OF THE EMBODIMENTS

A preferred embodiment of the present invention will now be exemplarily described in detail with reference to the accompanying drawings. Note that the relative arrangement of building components, display screens, and the like set forth in the embodiment do not intend to limit the scope of the invention to them, unless otherwise specified.

The embodiment will describe an example of transmitting information about the device status of a print apparatus by using a short distance wireless communication method. More specifically, the embodiment will explain a method of controlling automatic activation by short distance wireless communication such as NFC (Near Field Communication) when the print apparatus is in a state such as the soft-off state or sleep state.

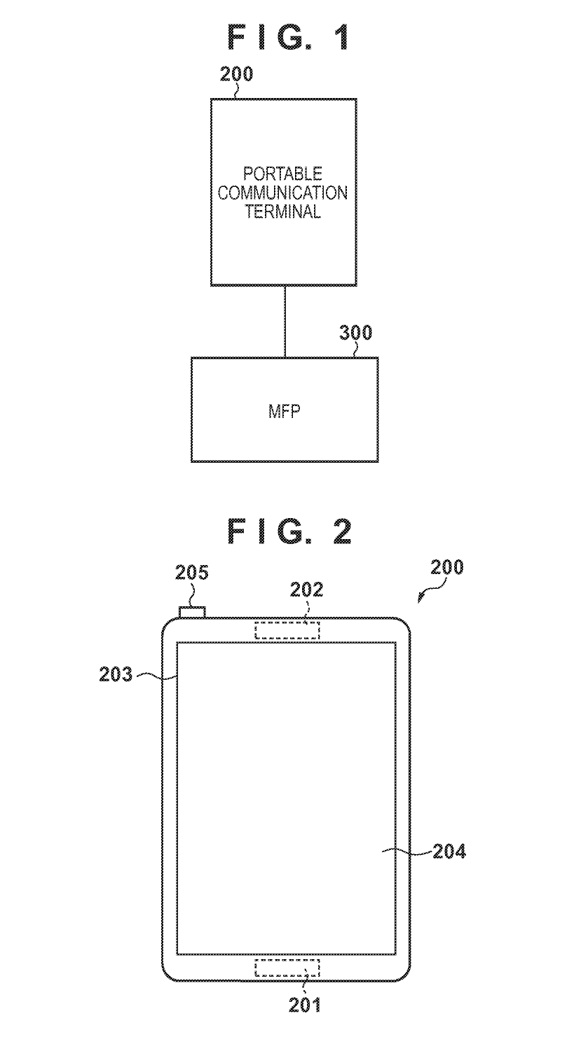

FIG. 1 is a view exemplifying the arrangement of an information processing system according to the embodiment. The information processing system includes the first portable information processing apparatus, and the second information processing apparatus which processes a job received from the first information processing apparatus. The embodiment will exemplify a portable communication terminal 200 as the first information processing apparatus, and an MFP (Multi Function Printer) 300 as the second information processing apparatus. The portable communication terminal 200 and MFP 300 can be connected to each other by NFC communication or the like. The portable communication terminal 200 is an arbitrary apparatus as long as it can handle an image file to be processed, such as a personal information terminal (for example, PDA (Personal Digital Assistant)), mobile phone, and digital camera. The MFP 300 has a reading function of reading an original placed on an original table, and a print function using a print unit such as an inkjet printer. As another function, the MFP 300 may have a FAX function and telephone function.

FIG. 2 is a view showing the outer appearance of the portable communication terminal 200. The embodiment will explain a case in which a smartphone is used as the portable communication terminal 200. The smartphone is a multifunctional mobile phone having the camera, net browser, mail functions, and the like, in addition to the mobile phone function. An NFC unit 201 is a portion which performs communication using NFC. When the NFC unit 201 is actually brought close to the NFC unit of a partner device within a range of about 10 cm, it can communicate. A wireless LAN (to be referred to as WLAN hereinafter) unit 202 is a unit for performing communication by WLAN and is incorporated in the apparatus. A display unit 203 is a display including an LCD display mechanism. An operation unit 204 includes a touch panel type operation mechanism, and detects information about pressing by the user. As a typical operation method, the display unit 203 presents a button-like display, and the user presses the operation unit 204 to issue an event corresponding to the pressed button. A power supply key 205 is used to turn on/off the power supply.

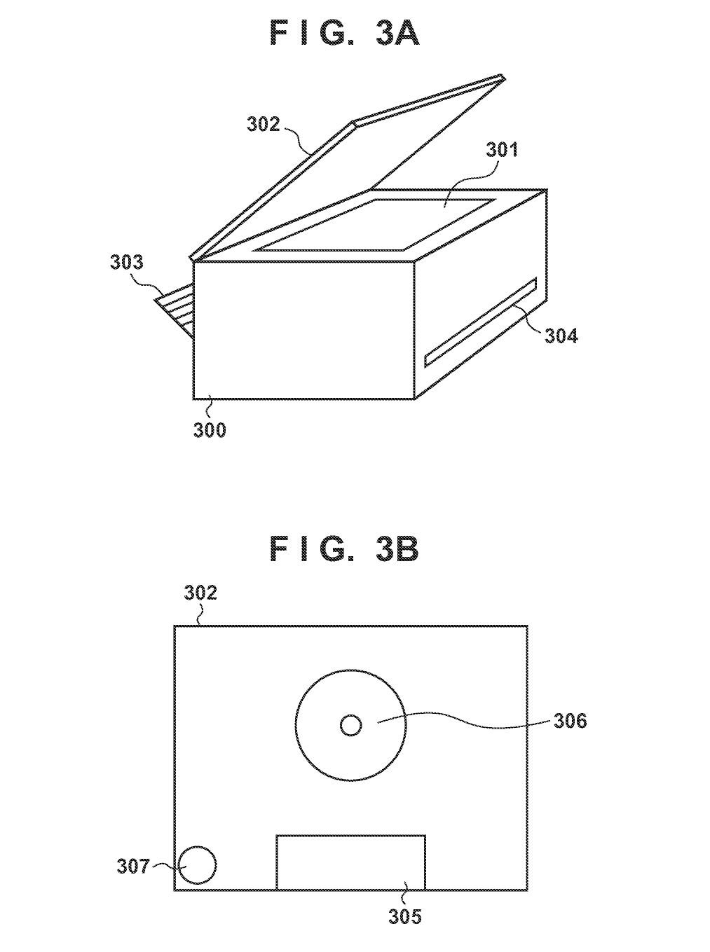

FIGS. 3A and 3B are views showing the outer appearance of the MFP 300. FIG. 3B is a view showing the outer appearance of the MFP 300 when viewed from the top. As shown in FIG. 3A, an original table 301 is a transparent glass table and is used to place an original and read it by a scanner. An original cover 302 is a cover for preventing external leakage of reading light in reading by the scanner. A print paper insertion port 303 is an insertion port in which sheets of various sizes are set. Sheets set in the print paper insertion port 303 are conveyed one by one to the print unit, undergo printing the user wants, and then are discharged from a print paper discharge port 304. As shown in FIG. 3B, an operation display unit 305 and NFC unit 306 are arranged on the original cover 302. The operation display unit 305 includes various input switches and a display for user operations, and allows the user to, for example, make various settings of the MFP 300 and confirm device information such as the device status and setting state. The NFC unit 306 is a unit for performing short distance wireless communication, and is a place to which the NFC unit of a communication partner apparatus is actually brought close. A distance of about 10 cm from the NFC unit 306 is the effective range of contact. A WLAN antenna 307 is an antenna for communication by WLAN, and is incorporated in the MFP 300.

Here, NFC communication will be explained. When performing short distance communication by the NFC unit, an apparatus which outputs an RF (Radio Frequency) field first and starts communication is called an initiator. An apparatus which responds to a command issued by the initiator and communicates with the initiator is called a target. The communication mode of the NFC unit includes a passive mode and active mode. In the passive mode, the target responds to a command from the initiator by performing load modulation. In the active mode, the target responds to a command from the initiator by using an RF field generated by the target itself.

FIGS. 4A and 4B are conceptual views of the passive mode in NFC communication. When an initiator 401 is to transmit data 404 to a target 402 in the passive mode, as shown in FIG. 4A, it generates an RF field 403 and establishes communication. The initiator 401 modulates the RF field 403 by itself and transmits the data 404 to the target 402. When a target 406 is to transfer data 408 to an initiator 405 in the passive mode, as shown in FIG. 4B, the initiator 405 generates an RF field 407, similar to FIG. 4A. The target 406 performs load modulation for the RF field 407 and transmits the data 408 to the initiator 405.

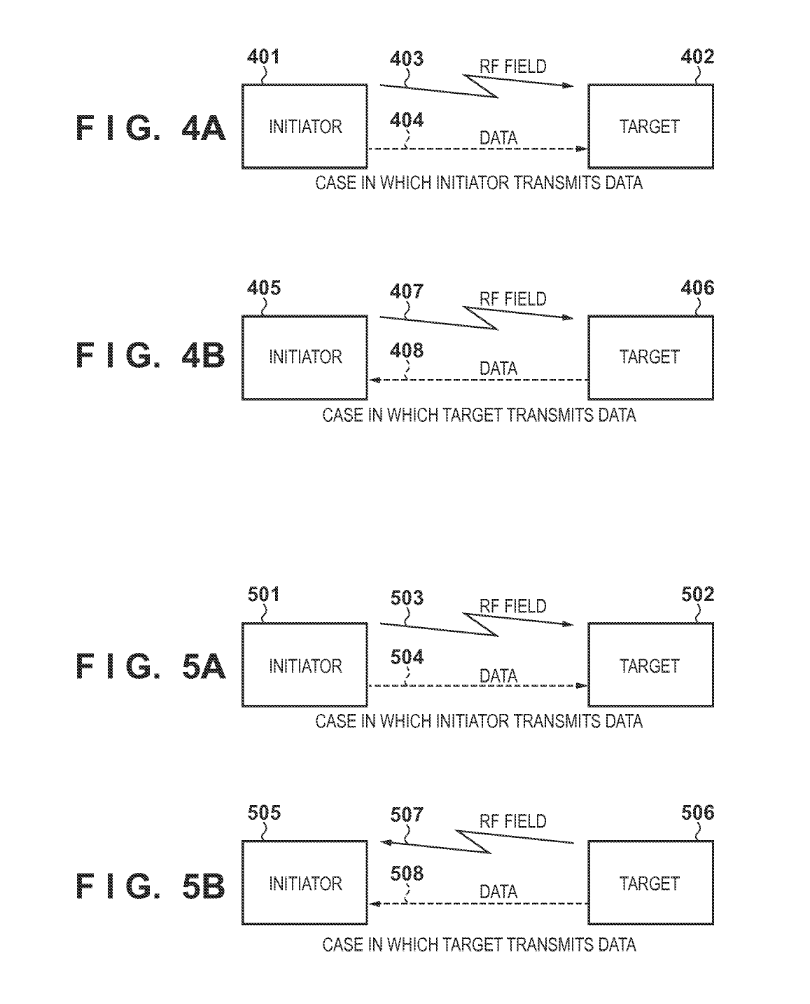

FIGS. 5A and 5B are conceptual views of the active mode in NFC communication. When an initiator 501 is to transmit data 504 to a target 502 in the active mode, as shown in FIG. 5A, it generates an RF field 503 and establishes communication. The initiator 501 modulates the RF field 503 by itself and transmits the data 504 to the target 502. Upon completion of the data transmission, the initiator 501 stops the output of the RF field 503. When a target 506 is to transmit data 508 to an initiator 505 in the active mode, as shown in FIG. 5B, the target 506 generates an RF field 507. The target 506 transmits the data 508 by the RF field 507 generated by itself, and after the end of the transmission, stops the output of the RF field 507.

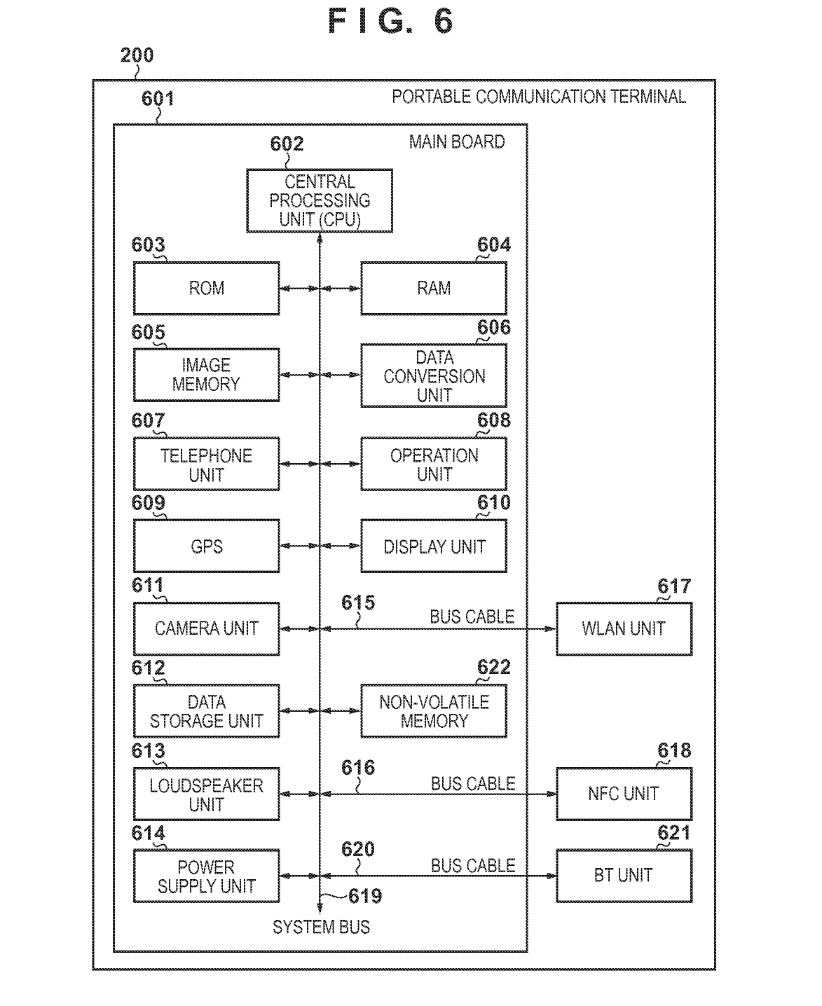

FIG. 6 is a block diagram showing the portable communication terminal 200. The portable communication terminal 200 includes a main board 601 which performs main control of the apparatus, a WLAN unit 617 which performs WLAN communication, an NFC unit 618 which performs NFC communication, and a BT unit 621 which performs Bluetooth® communication.

In the main board 601, a CPU 602 is a system control unit and controls the overall portable communication terminal 200. A ROM 603 stores control programs, an embedded operating system (OS) program, and the like to be executed by the CPU 602. In the embodiment, each control program stored in the ROM 603 executes software control such as scheduling or task switching under the management of the embedded OS stored in the ROM 603. A RAM 604 is formed from an SRAM (Static RAM) or the like, stores program control variables, set values registered by the user, management data of the portable communication terminal 200, and the like, and provides various work buffer areas.

An image memory 605 is formed from a DRAM (Dynamic RAM) or the like, and temporarily stores image data received via the communication unit and image data read out from a data storage unit 612 to process them by the CPU 602. A non-volatile memory 622 is formed from a flash memory or the like, and stores data which need to be saved even upon power-off. Examples of these data are telephone book data and information about devices connected in the past. Note that the memory configuration is not limited to the above-described one. For example, the image memory 605 and RAM 604 may be formed from a common memory, or data may be backed up in the data storage unit 612. The embodiment uses the DRAM as the image memory 605, but is not limited to this and may use a hard disk, non-volatile memory, or the like.

A data conversion unit 606 performs analysis of a page description language (PDL) and data conversion including color conversion and image conversion. A telephone unit 607 implements telephone speech communication by controlling the telephone line and processing audio data input/output via a loudspeaker unit 613. An operation unit 608 controls a signal from the operation unit 204 described with reference to FIG. 2. A GPS (Global Positioning System) 609 acquires the current latitude, longitude, and the like. A display unit 610 electronically controls the display contents of the display unit 203 described with reference to FIG. 2, and allows various input operations, display of the operation state and status of the MFP 300 (to be described in detail later), and the like.

A camera unit 611 has a function of electronically recording an image input via a lens, and encoding it. An image captured by the camera unit 611 is saved in the data storage unit 612. The loudspeaker unit 613 implements a function of inputting or outputting an audio for the telephone function, and another function such as alarm notification. A power supply unit 614 is a portable battery and controls it. The power supply state includes, for example, a battery dead state in which the battery level is 0, a power supply off state in which the power supply key 205 is not pressed, an activation state in which the portable communication terminal 200 is activated normally, and a power saving state in which power is saved though the portable communication terminal 200 is activated.

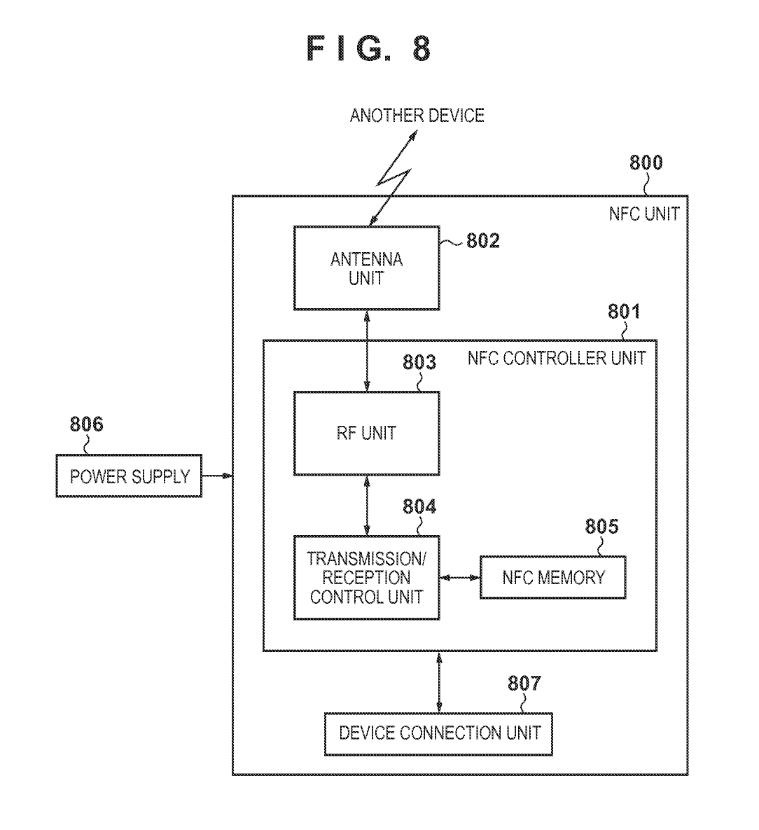

The portable communication terminal 200 includes three units for wireless communication, that is, the WLAN unit 617, NFC unit 618, and BT unit 621, and can perform wireless communication by WLAN, NFC, and Bluetooth®. The WLAN unit 617, NFC unit 618, and BT unit 621 are connected to a system bus 619 via bus cables 615, 616, and 620, respectively. These communication units convert data into packets in conformity with their standards, and transmit the packets to another device. In addition, these communication units convert packets from another external device into data, and transmit the data to the CPU 602. Details of the NFC unit 618 will be described later with reference to FIG. 8. The building components 603 to 614, 617, 618, 621, and 622 are connected to each other via the system bus 619 managed by the CPU 602.

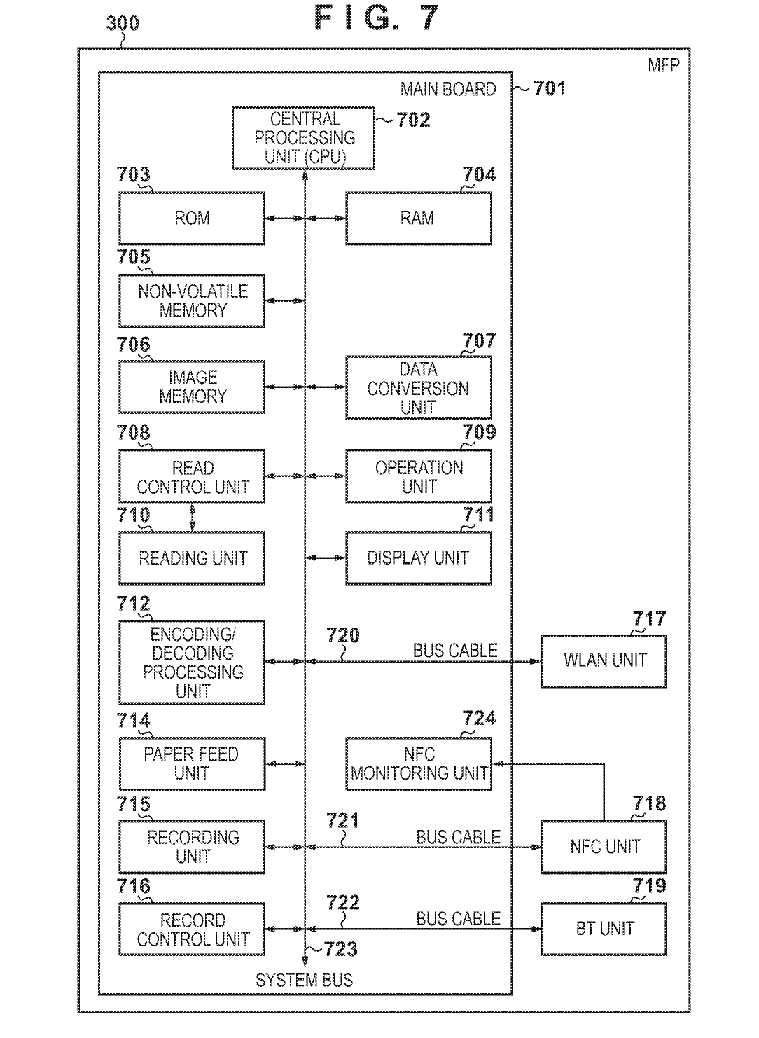

FIG. 7 is a block diagram showing the schematic arrangement of the MFP 300. The MFP 300 includes a main board 701 which performs main control of the apparatus, a WLAN unit 717 which performs WLAN communication, an NFC unit 718 which performs NFC communication, and a BT unit 719 which performs Bluetooth® communication.

In the main board 701, a CPU 702 is a system control unit and controls the overall MFP 300. A ROM 703 stores control programs, an embedded operating system (OS) program, and the like to be executed by the CPU 702. In the embodiment, each control program stored in the ROM 703 executes software control such as scheduling or task switching under the management of the embedded OS stored in the ROM 703.

A RAM 704 is formed from an SRAM (Static RAM) or the like, stores program control variables, set values registered by the user, management data of the MFP 300, and the like, and provides various work buffer areas. A non-volatile memory 705 is formed from a flash memory or the like, and stores data which need to be saved even upon power-off. Examples of these data are network connection information and user data. An image memory 706 is formed from a DRAM (Dynamic RAM) or the like, and stores image data received via each communication unit, image data processed by an encoding/decoding processing unit 712, image data acquired via a memory card controller 516, and the like. Similar to the memory configuration of the portable communication terminal 200, these memory configurations are not limited to the above ones. A data conversion unit 707 performs analysis of a page description language (PDL) and conversion from image data into print data.

A reading unit 710 optically reads an original by a CIS image sensor (contact image sensor) under the control of a read control unit 708. The read control unit 708 generates an image signal by converting a signal obtained by the reading unit 710 into electrical image data. The read control unit 708 performs various image processes such as binarization processing and halftone processing for the generated image data via an image processing control unit (not shown), and outputs high-resolution image data.

An operation unit 709 and display unit 711 correspond to the operation display unit 305 described with reference to FIGS. 3A and 3B. The encoding/decoding processing unit 712 performs encoding/decoding processing and enlargement/reduction processing for image data (for example, JPEG or PNG) handled by the MFP 300.

A paper feed unit 714 is a unit capable of holding paper for printing. Paper can be fed from the paper feed unit 714 under the control of a record control unit 716. A plurality of paper feed units can be prepared in the paper feed unit 714 to hold a plurality of types of sheets in one apparatus. The record control unit 716 can control a paper feed unit from which paper is fed.

The record control unit 716 performs various image processes such as smoothing processing, recording density correction processing, and color correction via an image processing control unit (not shown) for image data to be printed, converts the image data into high-resolution image data, and outputs the high-resolution image data to a recording unit 715. The record control unit 716 periodically reads out information of the print unit to update information in the RAM 704. More specifically, the record control unit 716 updates the remaining ink amount of an ink tank, the state of a printhead, and the like.

Similar to the portable communication terminal 200, the MFP 300 includes three units (the WLAN unit 717, NFC unit 718, and BT unit 719) for wireless communication. The WLAN unit 717, NFC unit 718, and BT unit 719 are connected to the system bus 723 via bus cables 720, 721, and 722, respectively. The functions of these communication units are the same as those of the communication units of the portable communication terminal 200. The building components 702 to 719 are connected to each other via the system bus 723 managed by the CPU 702. An NFC monitoring unit 724 receives power even when the MFP 300 is in the sleep state (power saving state) or the soft-off state, and monitors establishment of a short distance wireless communication in the NFC unit 718 or writing of a job by the short distance wireless communication. When the NFC monitoring unit 724 detects establishment of a communication in the NFC unit 718 or writing of a job, it controls resupply of power from soft-off or return from the sleep state. In the embodiment, when a job is written in an NFC memory 805 of the NFC unit 718, the NFC monitoring unit 724 controls to activate the MFP 300 from soft-off or return it from the sleep state. That is, when the portable communication terminal 200 is brought close to the MFP 300 in the soft-off state or sleep state, establishes a short distance wireless communication, and inputs a job by the short distance wireless communication, which will be described later, the MFP 300 automatically starts up to the normal activation state.

FIG. 8 is a block diagram for explaining details of the NFC unit which is adopted in the NFC units 618 and 718. The arrangement of an NFC unit 800 will be described with reference to FIG. 8. The NFC unit 800 includes an NFC controller unit 801, an antenna unit 802, an RF unit 803, a transmission/reception control unit 804, the NFC memory 805, and a device connection unit 807. Power is supplied from an external power supply 806 to the NFC unit 800. The antenna unit 802 receives radio waves or carriers from another NFC device, and transmits radio waves or carriers to another NFC device. The RF unit 803 has a function of modulating/demodulating an analog signal into a digital signal. The RF unit 803 includes a synthesizer, identifies band and channel frequencies, and controls the band and channel by frequency allocation data. The transmission/reception control unit 804 performs control regarding transmission/reception such as assembly and disassembly of a transmission/reception frame, addition and detection of a preamble, and frame identification. The transmission/reception control unit 804 also controls the NFC memory 805, and reads/writes various data and programs.

When the NFC unit 800 operates in the active mode, it receives supply of power from the power supply 806, and communicates with a device via the device connection unit 807 or another NFC device present within a range capable of communication using carriers transmitted/received via the antenna unit 802. When the NFC unit 800 operates in the passive mode, it receives a carrier from another NFC device via the antenna unit 802, receives supply of power from the NFC device by electromagnetic induction, communicates with the other NFC device by carrier modulation, and transmits/receives data.

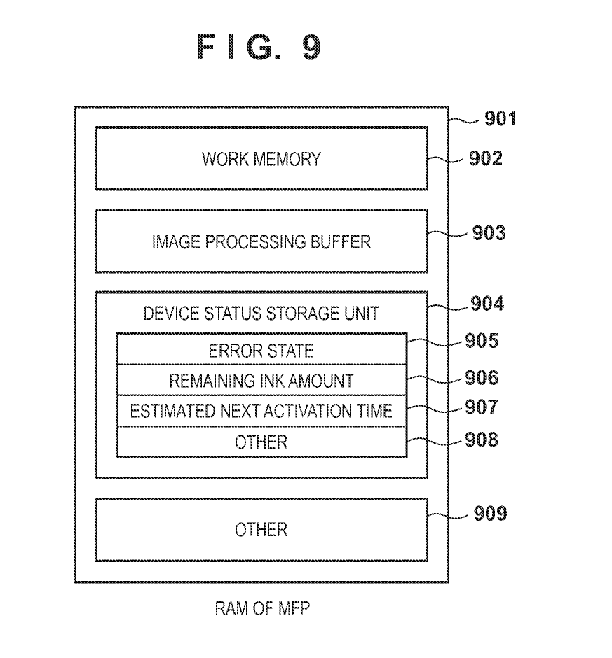

FIG. 9 is a block diagram exemplifying the data structure of the RAM 704 of the MFP 300. Reference numeral 901 denotes the overall RAM 704. A work memory 902 is a memory ensured for program execution. An image processing buffer 903 is an area used as a temporary buffer for image processing. A device status storage unit 904 stores various kinds of information (device information) about the current device status of the MFP 300. In FIG. 9, the device status storage unit 904 stores an error state 905, a remaining ink amount 906, an estimated next activation time 907, and others 908.

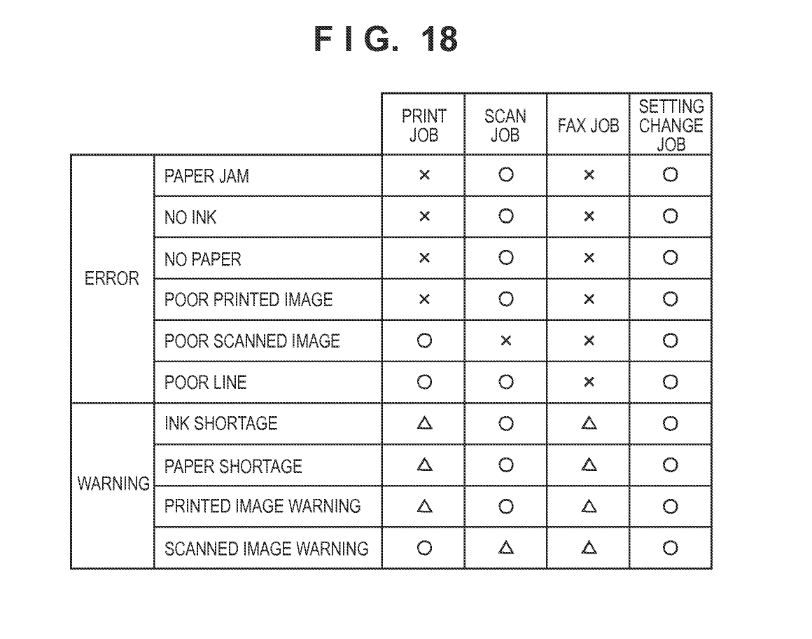

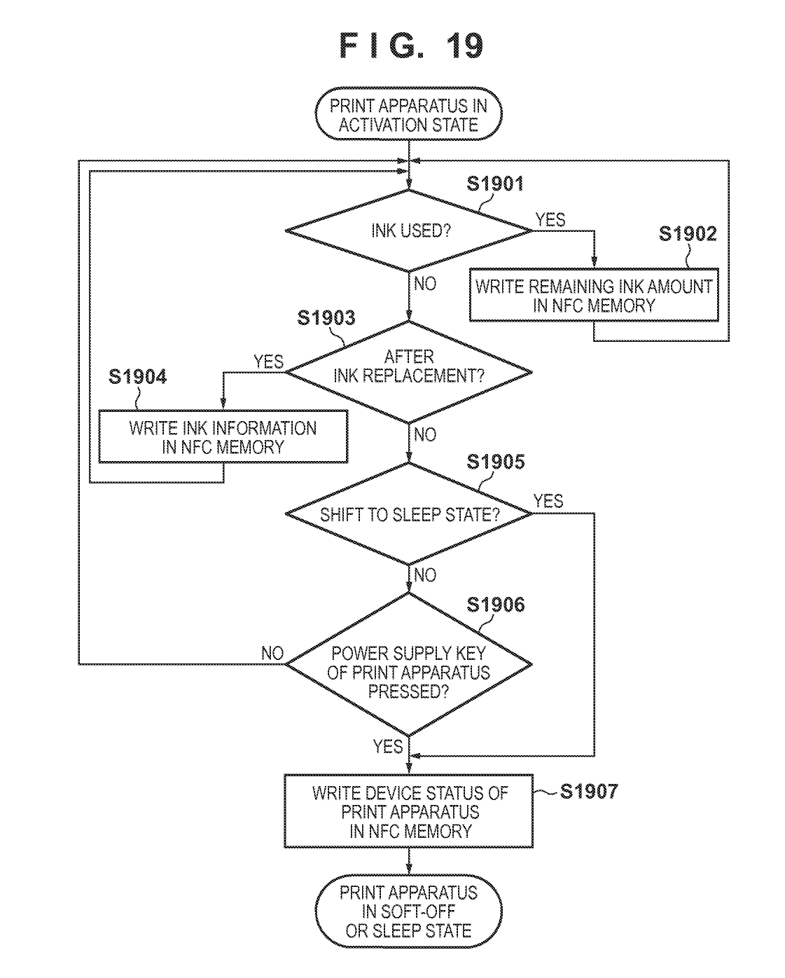

For example, the error state 905 is a state regarding an error in the MFP 300. Examples of the error are an ink shortage warning, ink out error, paper jam error, paper out warning, poor printed image warning, poor read image error, and network disconnection warning. These warnings and errors are associated with the degree of influence on the print function, that of influence on the reading function, and the like. For example, for the ink out error, the print function is unusable, but the reading function is usable. For the network disconnection warning, a function using a network is unusable, but a change of settings and the reading function which are performed in a standalone device are usable. This will be explained in detail later with reference to FIG. 18.

For example, the remaining ink amount 906 is device information representing the model number and remaining ink amount of a currently attached ink tank. The model number of the ink tank is updated at the timing when the ink tank is attached. The remaining ink amount is updated every time ink is used. The estimated next activation time 907 is the estimated activation time of the next activation after the power supply is turned off. The activation time of the MFP 300 greatly changes depending on the power supply state. For example, the power supply state of the MFP 300 includes the hard-off state, soft-off state, normal activation state, and sleep state. In the hard-off state, supply of power stops, and time is taken until the MFP 300 shifts from the hard-off state to the normal activation state upon receiving power. In the soft-off state, power is partially supplied, but the main program is not activated, and the MFP 300 can be activated within a time shorter than that in hard-off. In the sleep state, portions which consume large power are turned off, the remaining programs and mechanical portions operate, and thus the MFP 300 can quickly return to the normal activation state. Another factor which varies the activation time is a device error state. For example, when it is detected that many nozzles of an inkjet printhead are clogged, printing is accepted after performing long-time recovery processing in the next activation. When the light quantity of the scanner becomes small, the MFP 300 is activated after performing an adjustment operation, so a relatively long time is taken until the MFP 300 shifts to the operating state. In this manner, the estimated activation time of the next activation is determined based on state transition of the power supply and the device status. The others 908 store other device statuses such as the current memory utilization, hardware temperature, and consumables information. Others 909 store other RAM data.

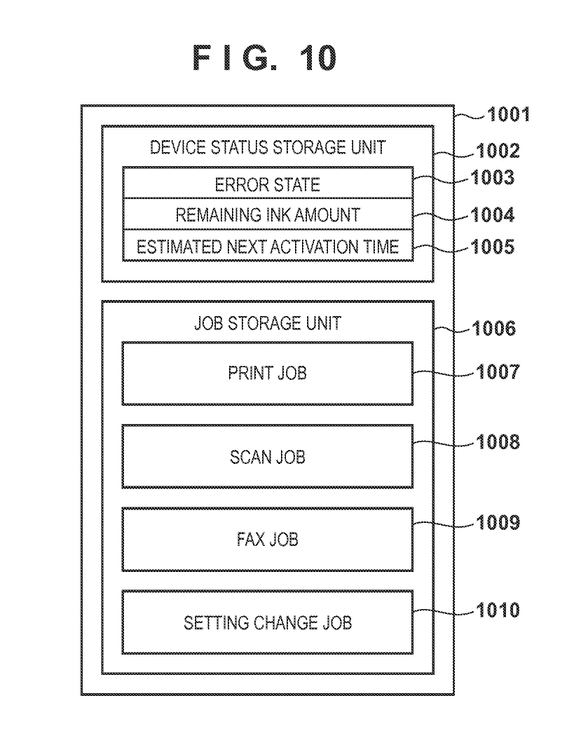

FIG. 10 exemplifies the data structure of the NFC memory 805 of the NFC unit 306 (NFC unit 718) arranged in the MFP 300. The NFC unit 306 can transmit/receive information to/from an external terminal by using passive mode communication even when no power is supplied to the MFP 300, and can read/write data from/in the NFC memory 805. Reference numeral 1001 denotes the overall NFC memory. The CPU 702 copies all or some contents of the device status storage unit 904 to a device status storage unit 1002 at a predetermined timing. Accordingly, the error state 905, remaining ink amount 906, and estimated next activation time 907 recorded in the RAM 704 are recorded in the NFC memory 805 as an error state 1003, remaining ink amount 1004, and estimated next activation time 1005. In FIG. 10, the others 908 are not copied, but the present invention is not limited to this. Arbitrary data such as data stored as the others 908, for example, a stored job may be stored.

A job storage unit 1006 is an area used when a job is input from the portable communication terminal 200 to the MFP 300 by NFC. In a print job 1007, a print job is queued. More specifically, print settings and a link destination to an image are stored. In a scan job 1008, a scan job is queued. More specifically, reading settings are stored. In a FAX job 1009, a FAX job is queued. More specifically, FAX settings including the telephone number of a transmission destination and the communication image quality are stored, and when an image has already been read, a link destination to the image is also stored. In a setting change job 1010, a setting change job is queued. More specifically, a job regarding a change of setting items of the main body is stored.

Device information is written in the NFC unit 306 at the timing when each device status changes or the timing of a shift to the sleep state or soft-off state. For example, a case in which the remaining ink amount is handled as the device information will be explained with reference to FIG. 19. FIG. 19 is a flowchart exemplifying processing of writing the device status of the MFP 300 in the NFC memory 805 of the NFC unit 306 (the NFC unit 718) by the CPU 702 of the MFP 300. The embodiment will describe a case in which the device status of the print apparatus of the MFP 300 is handled and the remaining ink amount is used as information (device information) representing the device status. In the embodiment, the NFC unit 306 writes device information in advance in the NFC memory 805 accessible by power supplied to the NFC unit 306 itself so that the portable communication terminal 200 can read the device information without activating the MFP 300. This can be implemented by setting the NFC unit 201 (the NFC unit 618) of the portable communication terminal 200 as the initiator, and exchanging data in the passive mode between the NFC units 201 and 306.

The timing when device information is written in the NFC memory 805 is preferably the timing when, for example, the device status may have changed. In particular, a case in which an inkjet printer is incorporated as the print apparatus of the MFP 300 will be exemplified. In steps S1901 and S1903, the timing when a change of the device information (that is, a change of the remaining ink amount) may have occurred is detected. When the print apparatus is active, first, in step S1901, the CPU 702 determines whether the print apparatus has used ink. If the print apparatus has used ink, the CPU 702 writes the remaining ink amount in the NFC memory (updates the remaining ink amount 1004 in the NFC memory 805) in step S1902, and returns the process to step S1901. The case in which the ink has used is, for example, a state after printing, preliminary discharge, or ink suction, and is a state in which the remaining ink amount may have changed. As described above, the remaining ink amount can be acquired from information recorded in the RAM 704 by the record control unit 716.

If no ink has been used, the CPU 702 determines in step S1903 whether the ink tank has been replaced. After the ink tank is replaced, the remaining ink amount changes, and the model number of the ink tank or the like may have changed. In step S1904, therefore, the CPU 702 writes ink information including the remaining ink amount and model number in the NFC memory (updates the remaining ink amount 1004 in the NFC memory 805). The ink information is written at either or both the timing when the ink tank is dismounted and the timing when it is mounted. If ink is supplied via a tube, the ink information is written when, for example, the sub-tank is refilled with ink and the remaining ink amount changes. After the end of writing the device information, the process returns to step S1901.

If no ink is replaced, the CPU 702 determines in step S1905 whether the print apparatus is to shift to the sleep state. If the CPU 702 determines that the print apparatus is to shift to the sleep state, it writes the device status of the print apparatus in the NFC memory in step S1907, and then shifts to the sleep state. The device status written here may include information such as the time when previous printing ended, an error, and a warning, in addition to the ink information. That is, the remaining ink amount 1004, error state 1003, and estimated next activation time 1005 in the NFC memory 805 are updated. For an electrophotographic printer, the device information written in the NFC memory 805 in steps S1902 and S1904 includes the remaining toner amount and the model number of the toner cartridge as internal information to be written in the NFC memory 805.

If the print apparatus is not to shift to the sleep state, the CPU 702 determines in step S1906 whether the power supply key of the MFP 300 has been pressed. If the power supply key has been pressed, the CPU 702 writes the device status of the print apparatus in the NFC memory in step S1907, and then shifts the MFP 300 to the soft-off state. Although the device status written at this time may be the same as that in a shift to the sleep state, different information such as the time of a shift to the soft-off state may be written. If the CPU 702 determines in step S1906 that the power supply key has not been pressed, the process returns to step S1901. Hence, the portable communication terminal 200 can acquire the device status by communicating with the NFC unit 306 (the NFC unit 718) of the print apparatus which has shifted to the soft-off state or sleep state. That is, when the portable communication terminal 200 is to acquire the device status, the print apparatus need not return from the sleep state or soft-off state. This can reduce the count at which an operation such as preliminary discharge irrelevant to information acquisition is performed.

Note that these processes need not be performed in the order shown in FIG. 19, and all of them need not be executed, so the processes may be added or omitted, as needed. Further, the device status writing function is implemented by sequential processes, but may be performed by, for example, event driving at each conditional branch. In this case, priority may be set arbitrarily.

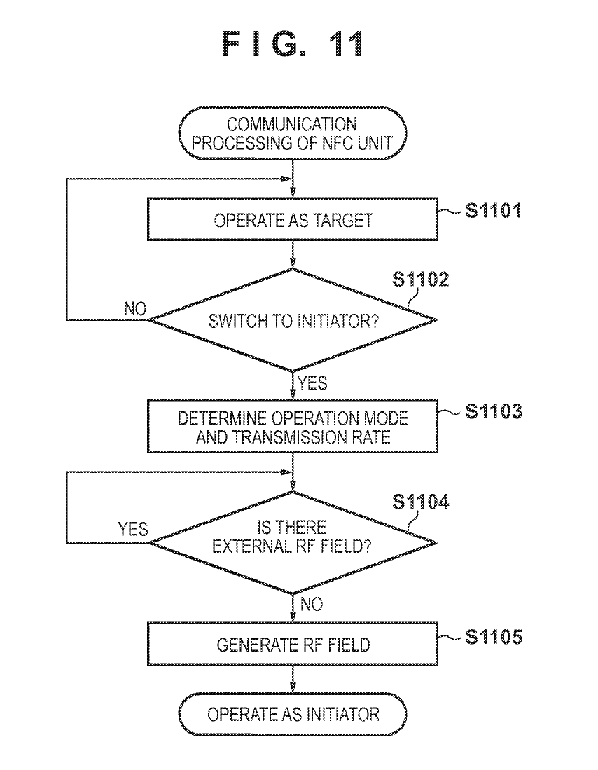

FIG. 11 is a flowchart showing processing when the NFC unit 800 operates as the initiator. First, in step S1101, the NFC unit 800 operates as the target and waits for a command from the initiator. Then, in step S1102, the NFC controller unit 801 determines whether an application which controls NFC communication has requested the NFC unit 800 to switch to the initiator. If the NFC unit 800 complies with a request to switch to the initiator, the application selects either the active mode or passive mode as the operation mode and determines the transmission rate in step S1103. In step S1104, the NFC controller unit 801 detects the presence of an RF field output from an apparatus other than the apparatus to which the NFC controller unit 801 belongs. If there is an external RF field, the initiator does not generate its RF field. If there is no external RF field, the process advances to step S1105, and the NFC controller unit 801 generates its RF field. Through these steps, the NFC unit 800 starts the operation as the initiator.

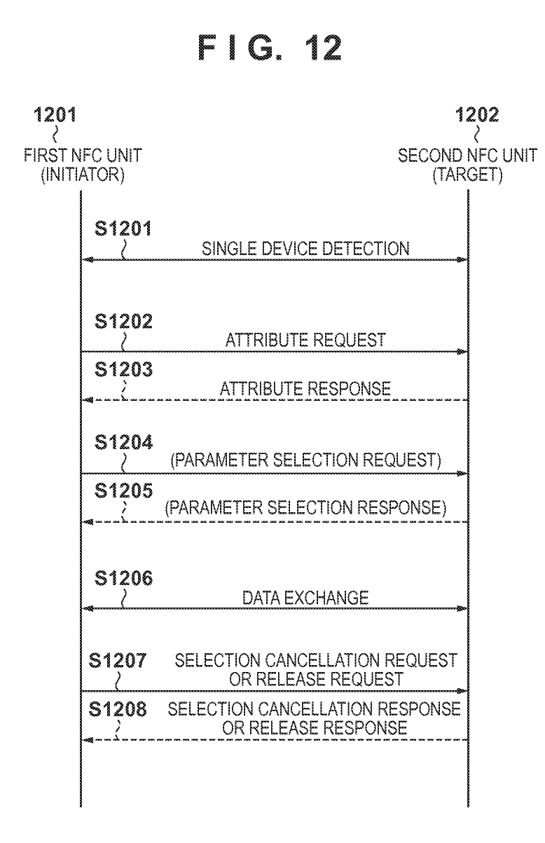

FIG. 12 shows a sequence to exchange data between NFC units in the passive mode. A case in which a first NFC unit 1201 operates as the initiator and a second NFC unit 1202 operates as the target will be explained.

First, in step S1201, the first NFC unit 1201 performs single device detection to specify the second NFC unit 1202. Then, in step S1202, the first NFC unit 1201 transmits its identifier, bit transmission rate in transmission/reception, effective data length, and the like as an attribute request. The attribute request has general bytes and can arbitrarily select and use them. If the second NFC unit 1202 receives an effective attribute request, it transmits an attribute response in step S1203. The transmission from the second NFC unit 1202 is performed by load modulation using the RF field generated by the first NFC unit 1201. In FIG. 12, data transmission by load modulation is expressed by dotted arrows.

After confirming an effective attribute response, the first NFC unit 1201 transmits a parameter selection request in step S1204 and can change the parameters of a subsequent transmission protocol. Parameters contained in the parameter selection request are the transmission rate and effective data length. If the second NFC unit 1202 receives an effective parameter selection request, it transmits a parameter selection response in step S1205 to change the parameters. If no parameter is changed, steps S1204 and S1205 may be skipped.

Then, in step S1206, the first NFC unit 1201 and second NFC unit 1202 exchange data in accordance with a data exchange request and data exchange response. The data exchange request and response can transmit, as data, information and the like for applications in the communication partners. When the data size is large, the data can be divided and transmitted.

After the end of the data exchange, the process shifts to step S1207, and the first NFC unit 1201 transmits either a selection cancellation request or release request. If the first NFC unit 1201 transmits the selection cancellation request, the second NFC unit 1202 transmits a selection cancellation response in step S1208. Upon receiving the selection cancellation response, the first NFC unit 1201 releases the attribute indicating the second NFC unit 1202, and the process returns to step S1201. If the first NFC unit 1201 transmits the release request, the second NFC unit 1202 transmits a release response in step S1208 and returns to the initial state. If the first NFC unit 1201 receives the release response, the target has completely been released, and the first NFC unit 1201 may return to the initial state.

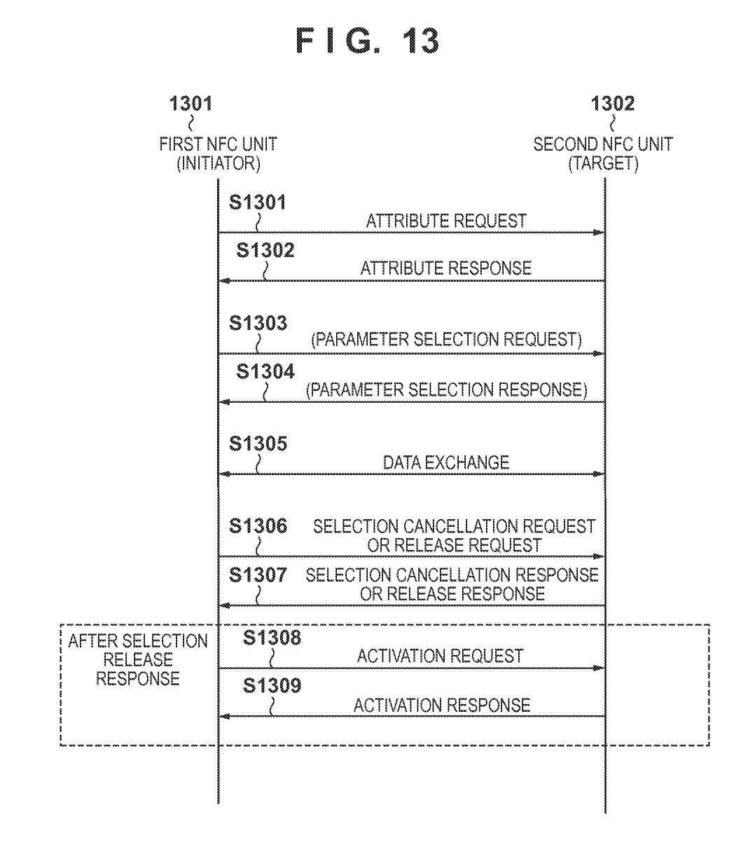

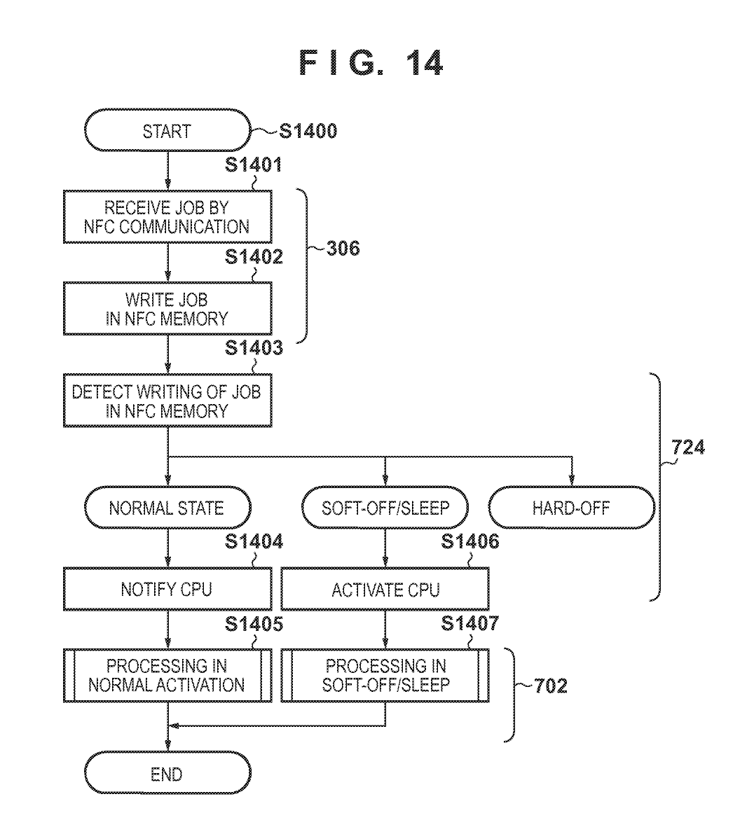

FIG. 13 shows a sequence to exchange data in the active mode. A case in which a first NFC unit 1301 operates as the initiator and a second NFC unit 1302 operates as the target will be explained.

First, in step S1301, the first NFC unit 1301 transmits its identifier, bit transmission rate in transmission/reception, effective data length, and the like as an attribute request. If the second NFC unit 1302 receives an effective attribute request, it transmits an attribute response in step S1302. The transmission from the second NFC unit 1302 is performed by an RF field generated by itself. Thus, the first and second NFC units stop the output of the RF field after the end of data transmission.

After confirming an effective attribute response, the first NFC unit 1301 transmits a parameter selection request in step S1303 and can change the parameters of a transmission protocol. Parameters contained in the parameter selection request are the transmission rate and effective data length. If the second NFC unit 1302 receives an effective parameter selection request, it transmits a parameter selection response in step S1304 to change the parameters. Similar to the passive mode, if no parameter is changed, steps S1303 and S1304 may be skipped.

Then, in step S1305, the first NFC unit 1301 and second NFC unit 1302 exchange data in accordance with a data exchange request and data exchange response. The data exchange request and response can transmit, as data, information and the like for applications. When the data size is large, the data can be divided and transmitted.

After the end of the data exchange, the process shifts to step S1306, and the first NFC unit 1301 transmits either a selection cancellation request or release request. If the first NFC unit 1301 transmits the selection cancellation request, the second NFC unit 1302 transmits a selection cancellation response in step S1307. Upon receiving the selection cancellation response, the first NFC unit 1301 releases the attribute indicating the second NFC unit 1302. In step S1308, the first NFC unit 1301 transmits an activation request to another target having a known identifier. Upon receiving the activation request, the target transmits an activation response in step S1309, and the process returns to step S1301. If the first NFC unit 1301 transmits the release request in step S1306, the second NFC unit 1302 transmits a release response in step S1307 and returns to the initial state. If the first NFC unit 1301 receives the release response, the target has completely been released, and the first NFC unit 1301 may return to the initial state.

FIG. 14 is a flowchart for explaining the operation of the MFP 300 in the information processing system according to the embodiment in which the portable communication terminal 200 can transmit a job to the MFP 300 by using NFC communication. In the information processing system, different processing is executed in accordance with input of a job by NFC communication based on the power supply state of the MFP 300. First, in step S1401, the NFC unit 306 of the MFP 300 receives a job transmitted from the NFC unit 201. Then, in step S1402, the NFC unit 306 of the MFP 300 writes the received job in the job storage unit 1006 of the NFC memory 805 of the NFC unit 306. As described with reference to FIG. 10, a write destination in the NFC memory 805 changes for each job type.

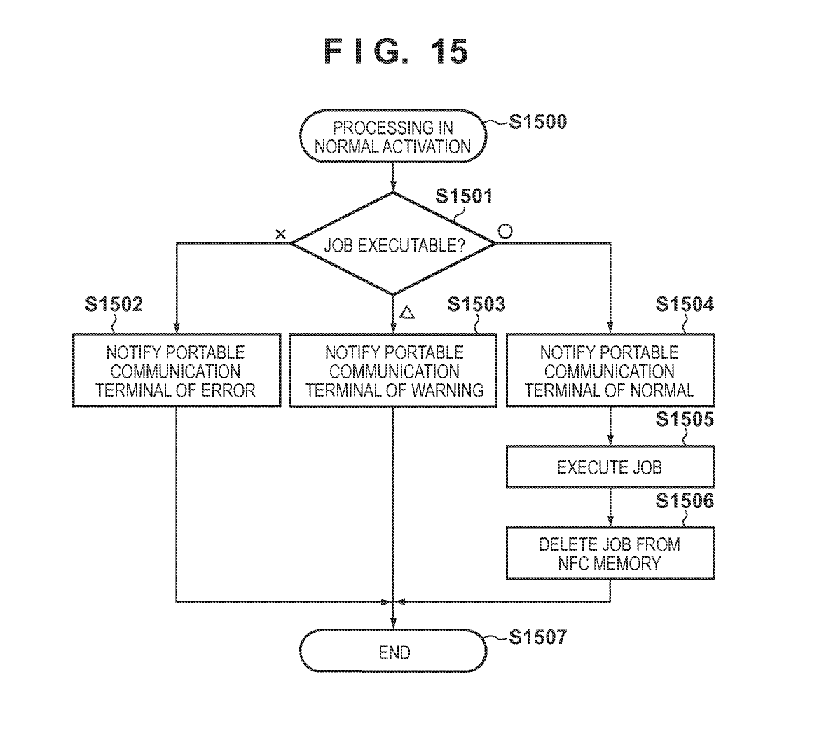

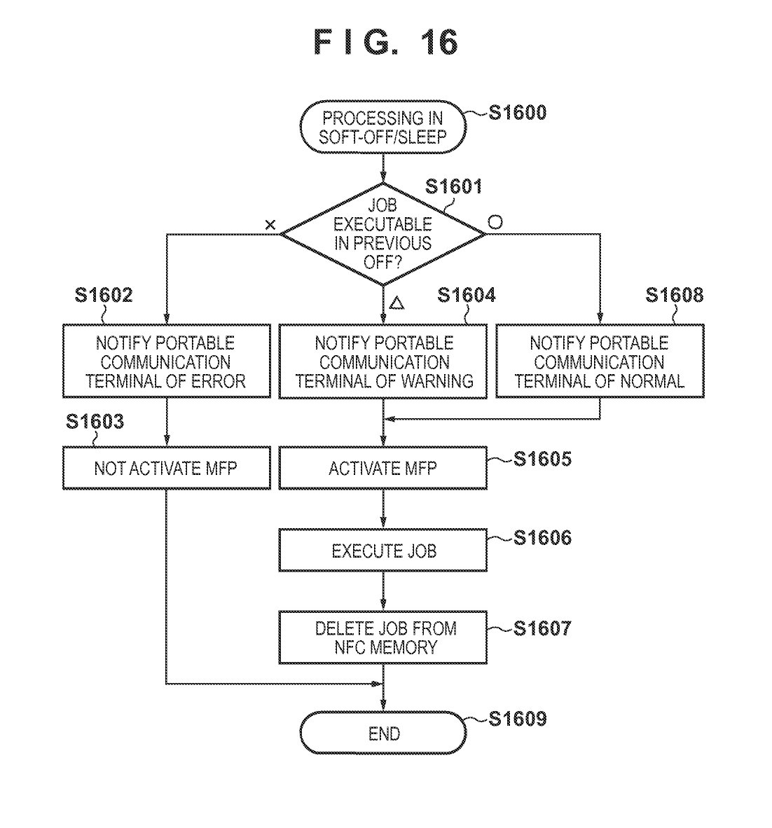

In step S1403, if the NFC monitoring unit 724 detects that the job has been written in the NFC memory 805, it operates as follows in accordance with the power supply state of the MFP 300:
When the MFP 300 is in the hard-off state, it does not operate except for the NFC unit 306 capable of receiving power supply via the RF field of an external apparatus.
When the MFP 300 operates in the normal activation state, the NFC monitoring unit 724 notifies in step S1404 the CPU 702 that the writing of the job has occurred. Upon receiving this notification, the CPU 702 executes processing in normal activation (to be described in detail with reference to FIG. 15) in step S1405.
When the MFP 300 is in the soft-off or sleep state, the NFC monitoring unit 724 activates or returns the CPU 702. At this time, the CPU 702 does not immediately return to the normal activation state, and executes processing in soft-off/sleep (to be described in detail with reference to FIG. 16) in step S1407.

FIG. 15 is a flowchart showing processing when a job is input from the NFC unit 306 while the MFP 300 operates in the normal activation state, that is, the processing in step S1405. In step S1501, the CPU 702 determines whether the input job can be executed. For this determination, a table shown in FIG. 18 is used.

FIG. 18 will be explained. FIG. 18 shows whether each type of job can be executed for each type of error or warning. × represents that a job cannot be executed, ◯ represents that a job can be executed, and Δ is a warning and represents that a job can be executed but a trouble may occur. For example, when a paper jam error has occurred, neither a print job nor FAX job can be executed, but a scan job and setting change job can be executed. When an ink shortage warning has been generated, printing may become faint or ink may run out during printing for a print job and FAX job. Note that the information about these errors and warnings can be read out from the error state 905 as long as the RAM 704 of the MFP 300 is usable. Even when the MFP 300 is in the hard-off or soft-off state and the RAM 704 cannot be used, the NFC unit 306 can read out the information about these errors and warnings from the error state 1003 (FIG. 10) in the NFC memory 805.

Referring back to FIG. 15, in step S1501, the CPU 702 determines, based on the table in FIG. 18, whether the input job can be executed. In this case, since the MFP 300 is in the normal activation state, the CPU 702 acquires a device status such as the error state 905 or remaining ink amount 906 from the device status storage unit 904 in the RAM 704, and executes the determination complying with the table of FIG. 18. If the CPU 702 determines that the input job cannot be executed, it advances the process to step S1502; if it determines that a warning has been generated, to step S1503; if it determines that the input job can be executed, to step S1504. In step S1502, the CPU 702 notifies the portable communication terminal 200 of the error by using NFC communication via the NFC unit 306. In step S1503, the CPU 702 notifies the portable communication terminal of the warning by using NFC communication via the NFC unit 306. Hence, the user can immediately recognize via the portable communication terminal 200 that the error or warning has been generated for the input job. When notifying a determination result such as an error or warning in step S1502 or S1503, if the CPU 702 notifies the reason of the error or warning, too, the portable communication terminal 200 can notify the user of more detailed information.

In step S1504, the CPU 702 notifies the portable communication terminal 200 via the NFC unit 306 that the MFP 300 will be normally activated to process the job, that is, of normal. Therefore, the user can immediately recognize that the input job will be normally executed. In step S1505, the CPU 702 executes the received job. In step S1506, the CPU 702 deletes the executed job from the job storage unit 1006 of the NFC memory 805. In step S1507, the sequence ends.

FIG. 16 shows a sequence (step S1407) when the MFP 300 is soft-off or in the sleep state and a job is input from the NFC unit 306. As described above, the NFC monitoring unit 724 of the MFP 300 monitors the communication state of the NFC unit 306 (the NFC unit 718) and the MFP 300 can be automatically activated from soft-off or the sleep state. In activation from soft-off or return from the sleep state, the CPU 702 determines whether activation or return has started in response to a signal from the NFC monitoring unit 724. If the CPU 702 determines that activation or return has started in response to a signal from the NFC monitoring unit 724, it executes processing shown in FIG. 16 in return to the normal activation state.

In step S1601, the CPU 702 determines whether the input job can be executed. In this case, the MFP 300 is not in the normal activation state, and neither read nor write can be performed for the RAM 704. By referring to device information such as the error state 1003 and remaining ink amount 1004 recorded in the NFC memory 805, the CPU 702 determines whether the job can be executed. If the CPU 702 determines in step S1601 that the job cannot be executed, the process advances to step S1602; if it determines that a warning has been generated, to step S1604; if it determines that the job can be executed, to step S1608. In step S1602, the CPU 702 notifies the portable communication terminal 200 of the error via the NFC unit 306. In step S1603, the MFP 300 is not activated and keeps soft-off or the sleep state. With this setting, the user can be notified of the error without starting up the MFP 300 to the normal activation state.

In step S1604, the CPU 702 notifies the portable communication terminal 200 of the warning via the NFC unit 306. From this, the user can immediately recognize the warning state. In step S1608, the CPU 702 notifies the portable communication terminal 200 via the NFC unit 306 that the MFP 300 will be normally activated to process the job, that is, of normal. The user can immediately recognize that the input job will be normally executed. When notifying a determination result such as an error or warning in step S1602 or S1603, if the CPU 702 notifies the reason of the error or warning, too, the portable communication terminal 200 can notify the user of more detailed information. In step S1605, the CPU 702 activates the MFP 300 to shift to the normal activation state. As described above, it is controlled to perform automatic activation when a job can be executed, and not to perform activation to the normal activation state when no job can be executed. Thus, the MFP 300 can be controlled to avoid wasteful activation. After the MFP 300 shifts to the normal activation state, the CPU 702 executes in step S1606 the job which has been written in the job storage unit 1006 of the NFC memory 805 in step S1402. In step S1607, the CPU 702 deletes the executed job from the job storage unit 1006, and ends the sequence.

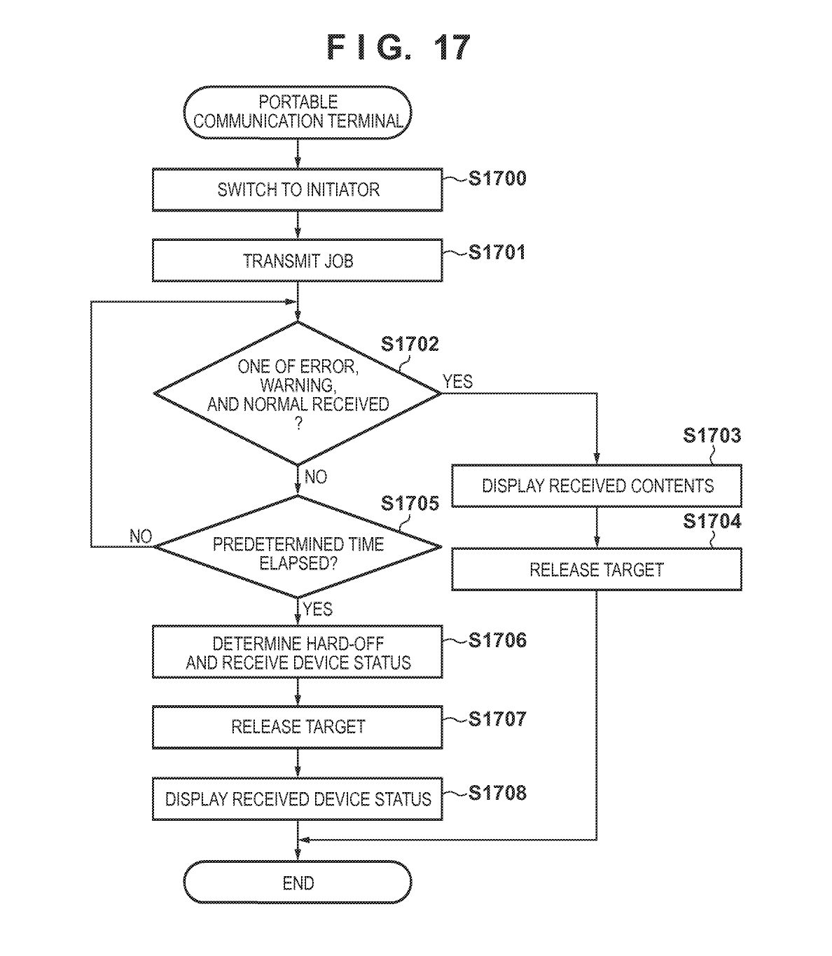

FIG. 17 is a flowchart showing processing from input of a job up to release of a target by the portable communication terminal 200. When a job input application is activated in the portable communication terminal 200, the user can select one of a print job, scan job, FAX job, and setting change job from the display unit 203 and operation unit 204. For the print job and FAX job, the user can designate image data to be processed. After the job is selected, the processing in FIG. 17 starts. In step S1700, the CPU 602 switches the NFC unit 201 to the initiator. After the NFC unit 201 serves as the initiator through the processing shown in FIG. 11, the CPU 602 transmits the job selected by the user to the MFP 300 by using the NFC unit 201 in step S1701.

As described above, if the MFP 300 is in one of the normal activation state, soft-off state, and sleep state upon receiving the job, it transmits a notification of one of an error, warning, and normal via the NFC unit 306. In step S1702, the CPU 602 of the portable communication terminal 200 determines whether the NFC unit 201 has received one of the error, warning, and normal. If the CPU 602 determines that the NFC unit 201 has received one of them, it advances the process to step S1703. The CPU 602 displays the received contents on the display unit 203 in step S1703, and transmits a release request to release the target in step S1704. The display in step S1703 notifies the user which of the error, warning, and normal has been received.

When the reason of the error or warning is also transmitted in step S1502 or S1503 of FIG. 15 or step S1602 or S1603 of FIG. 16, it can be displayed to notify the user of more detailed information. When the NFC unit 201 serves as the initiator, the NFC unit 306 serves as the target, and communication is performed in the passive mode, the portable communication terminal 200 can acquire device information from the NFC memory of the MFP 300 and displays the reason of the error and warning. In this case, the processing of transmitting the reason of the error or warning in step S1502, S1503, S1602, or S1603 can be omitted.

If a notification of any one of an error, warning, and normal has not been received within a predetermined time, the process advances from step S1705 to step S1706. In step S1706, the CPU 602 determines that the MFP 300 as the communication partner is in the hard-off state, and acquires device information stored in the NFC memory 805 of the NFC unit 306 via the NFC unit 201. After that, the CPU 602 transmits a release request to release the target in step S1707, and displays the device information acquired in step S1706 on the display unit 203 in step S1708. At this time, whether the job transmitted in step S1701 can be executed may be determined using the device information acquired in step S1706 and the relationship shown in FIG. 18, and the determination result may be displayed.

By the above-described processing, the portable communication terminal 200 which has transmitted the job can immediately recognize the processing status of the input job, and when the MFP 300 is hard-off, can recognize the device status of the MFP 300.

As described above, according to the embodiment, when a job is input to the MFP 300 in the sleep state or soft-off state, whether to automatically activate the MFP 300 is determined from the device status of the MFP 300. This can avoid wasteful activation (return) to the normal activation state. For example, an unwanted situation in which the job cannot be processed even upon activation can be avoided. Some apparatuses consume consumables and large power in activation, and even such a waste can be avoided.

When an error which makes execution of a job impossible occurs, the portable communication terminal 200 displays the reason of generation of the error, and the user can take a measure against it. Further, if it is determined that a job can be executed but processing of the job may be affected, the MFP 300 notifies the portable communication terminal 200 of the warning and reason indicative of this. Hence, the user can immediately recognize the risk in processing the job (without waiting until the MFP 300 starts up to the normal activation state).

Short distance wireless communication between apparatuses has been described on the premise of NFC communication in the passive mode in the embodiment, but is not limited to this. It is only necessary that short distance wireless communication in the MFP 300 is implemented by a communication unit which can operate in the sleep state and soft-off state, and the communication method may be infrared communication or the like. However, when infrared communication or NFC communication in the active mode is used, no device information can be received while the MFP 300 is hard-off.

The present invention is also implemented by executing the following processing. More specifically, software (program) for implementing the functions of the above-described embodiment is supplied to a system or apparatus via a network or various storage media, and the computer (or a CPU or MPU) of the system or apparatus reads out and executes the program. The program may be executed by a single computer or a plurality of computers in cooperation. Further, hardware such as a circuit for executing part of the program may be arranged, and the processing described in the embodiment may be executed by cooperation between the hardware and the computer which executes the software.

Aspects of the present invention can also be realized by a computer of a system or apparatus (or devices such as a CPU or MPU) that reads out and executes a program recorded on a memory device to perform the functions of the above-described embodiment(s), and by a method, the steps of which are performed by a computer of a system or apparatus by, for example, reading out and executing a program recorded on a memory device to perform the functions of the above-described embodiment(s). For this purpose, the program is provided to the computer for example via a network or from a recording medium of various types serving as the memory device (for example, computer-readable storage medium).

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2012-048619, filed Mar. 5, 2012, which is hereby incorporated by reference herein in its entirety.

What is claimed is:

1. An apparatus comprising:
a communication unit configured to be able to perform wireless communication with a communication device in a sleep state or a soft-off state;
a storage unit configured to store device information representing a device status of the apparatus in a memory accessible when said communication unit performs the wireless communication;
a determining unit configured to determine, based on the device information stored in the memory, whether to execute predetermined processing in the sleep state or the soft-off state; and
a control unit configured to, when said determining unit determines to execute the predetermined processing, shift the apparatus from the sleep state or the soft-off state to an activation state and execute the predetermined processing, and when said determining unit determines not to execute the predetermined processing, keep the sleep state or the soft-off state.

2. The apparatus according to claim 1, wherein said determining unit makes the determination when said communication unit receives a job for executing the predetermined processing.

3. The apparatus according to claim 1, further comprising a notification unit configured to notify an external apparatus of a determination result of said determining unit by said communication unit.

4. The apparatus according to claim 1, wherein said control unit deletes the job from the memory after executing the job.

5. The apparatus according to claim 1, wherein said communication unit performs NFC, and operates as a target in a passive mode in the sleep state or the soft-off state.

6. The apparatus according to claim 1, wherein said determining unit determines, based on a type of the job and the device information, whether the job can be executed.

7. The apparatus according to claim 1, wherein said storage unit stores the device information in the memory when the apparatus shifts from the activation state to the sleep state or the soft-off state.

8. The apparatus according to claim 1, wherein said storage unit stores, as the device information in the memory, a result of executing the predetermined processing in accordance with an instruction when execution of the predetermined processing is instructed.

9. The apparatus according to claim 1, wherein the predetermined processing includes print processing.

10. A method of controlling an apparatus including a communication unit configured to be able to perform wireless communication with a communication device in a sleep state or a soft-off state, comprising:
a storage step of storing device information representing a device status of the apparatus in a memory accessible when the communication unit performs the wireless communication;
a determining step of determining, based on the device information stored in the memory, whether to execute predetermined processing in the sleep state or the soft-off state; and
a control step of, when the predetermined processing is determined in the determining step to be executed, shifting the apparatus from the sleep state or the soft-off state to an activation state and executing the predetermined processing, and when the predetermined processing is determined in the determining step not to be executed, keeping the sleep state or the soft-off state.

11. The method according to claim 10, wherein in the determining step, the determination is made when the communication unit receives a job for executing the predetermined processing.

12. The method according to claim 10, further comprising a notification step of notifying an external apparatus of a determination result of the determining step by the communication unit.

13. The method according to claim 10, wherein in the control step, the job is deleted from the memory after executing the job.

14. The method according to claim 10, wherein the communication unit performs NFC, and operates as a target in a passive mode in the sleep state or the soft-off state.

15. The method according to claim 10, wherein in the determining step, whether the job can be executed is determined based on a type of the job and the device information.

16. The method according to claim 10, wherein in the storage step, the device information is stored in the memory when the apparatus shifts from the activation state to the sleep state or the soft-off state.

17. The method according to claim 10, wherein in the storage step, a result of executing the predetermined processing in accordance with an instruction when execution of the predetermined processing is instructed is stored as the device information in the memory.

18. The method according to claim 10, wherein the predetermined processing includes print processing.

19. A non-transitory computer readable storage medium storing a program for causing a computer to execute steps of a method defined in claim 10.
